(19) United States
(12) Patent Application Publication
(10) Pub. No.: US 2015/0205742 A1
(43) Pub. Date: Jul. 23, 2015

(54) SWITCHING BOX AND METHOD OF SHARING PERIPHERAL DEVICE

(71) Applicant: HON HAI PRECISION INDUSTRY CO., LTD., New Taipei (TW)

(72) Inventors: PO-CHOU HSIEH, New Taipei (TW); YEN-TING CHEN, New Taipei (TW)

(73) Assignee: HON HAI PRECISION INDUSTRY CO., LTD., New Taipei (TW)

(21) Appl. No.: 14/227,018

(22) Filed: Mar. 27, 2014

(30) Foreign Application Priority Data
Jan. 22, 2014 (TW) 103102209

(51) Int. Cl. G06F 13/40; G06F 13/38; G06F 11/30

(52) U.S. Cl. CPC G06F 13/4022; G06F 11/3041; G06F 13/385

(57) ABSTRACT

A switch, connecting to a plurality of terminal equipment as well as at least one peripheral device, includes a register module, a monitoring module, and a switching module. The register module assigns information for registered terminal equipment including an exclusive frequency and an exclusive hot key. The monitoring module monitors whether the exclusive hot key is trigged on a peripheral device. The switching module cuts off a connection with the current terminal equipment and causes the switch box to connect with another terminal device at another exclusive frequency. A method for sharing the peripheral device is also provided.

### BACKGROUND

1. Technical Field

Embodiments of the present disclosure generally relate to switching boxes, and more particularly to a switching box switching among a plurality of terminal equipment to share peripheral devices and a method of sharing a peripheral device.

2. Description of Related Art

Owning a plurality of terminal equipment such as computers is common. Sharing one peripheral device such as a mouse or a keyboard for the plurality of terminal equipment is convenient.

Currently, most of the switching devices which are connected to the terminal equipment by PS/2, VGA cable, or USB, h need transmission lines. Many transmission lines are needed when there are a large number of terminal equipment. In addition, the transmission lines may be cluttered, and any change to the location of the terminal equipment can be very inconvenient to the users.

It is desirable to provide a switching box to share peripheral devices and a method of sharing peripheral devices to solve the problems mentioned above.

### BRIEF DESCRIPTION OF THE DRAWINGS

FIG. 1 is a schematic diagram of an application environment of one embodiment of a switching box, showing one example of operation of the application environment.

FIG. 2 is a block diagram of functional modules of a switching box in FIG. 1.

FIG. 3 is a flowchart of one embodiment of a method of sharing peripheral device.

FIG. 4 is a flowchart of one embodiment of the registration of terminal equipment, the process is indicated by the switching box.

FIG. 5 is a flowchart of one embodiment of the switching box to switch the terminal equipment.

### DETAILED DESCRIPTION

The embodiments are illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used hereinafter, refers to logic embodied in hardware or firmware, or to a collection of software instructions, written in a programming language such as, for example, Java, C, or assembly. One or more software instructions in the units may be embedded in firmware such as in an erasable-programmable read-only memory (EPROM). It will be appreciated that units may comprise connected logic units, such as gates and flip-flops, and may comprise programmable units, such as programmable gate arrays or processors. The units described herein may be implemented as either software and/or hardware units and may be stored in any type of computer-readable medium or other computer storage device.

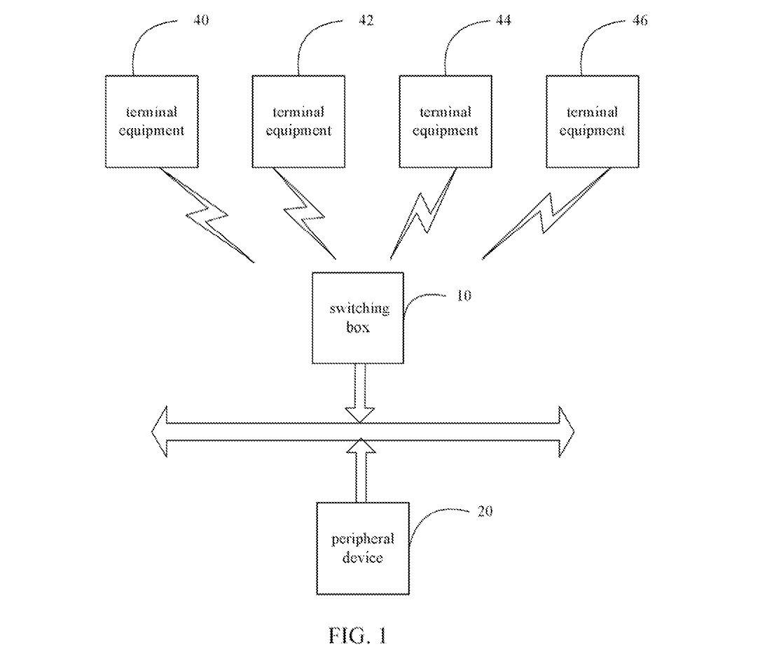

FIG. 1 is a schematic diagram of one embodiment of an application environment of a switching box 10. In one embodiment, the switching box 10, the peripheral device 20 and a plurality of terminal equipment 40, 42, 44, 46 collectively form an application environment. In one embodiment, the terminal equipment 40-46 are at least one computing terminal or other electric devices such as PADs and the four shown is not as a limitation to the present disclosure. In one embodiment, the peripheral devices 20 can be one or more input devices, for example, a mouse or a keyboard.

In one embodiment, the switching box 10 connects to the terminal equipment 40, 42 at a frequency via WIFI Direct network. If one of the terminal equipment is connected first, the connection is established by way of “persistent-connect,” or the connection would be established by way of “re-association” if the connection is not the first. “Persistent-connect” is a network-connected way, which requests safety information offered by the connected terminal equipment. “Re-association” is another network-connected way, which allows the connected terminal equipment to reconnect quickly without safety authority.

In general, WIFI Direct is an emerging wireless standard that allows you to create a connection between any two devices without going through a wireless router. Devices can make a one-to-one connection, or a group of several devices can connect simultaneously if they support WIFI Direct. In one embodiment, not only the switching 10 but also the terminal equipments 40-46 must support WIFI Direct and pre-install an appropriate driver so that the switching box 10 can scan the terminal equipment 40-46 and achieve corresponding functions. The switching box 10 can form a group with the terminal equipment 40-46 respectively and act as group owner of all the groups that have been formed.

In one embodiment, the switching box 10 and the peripheral device 20 can be connected together via USB, PS/2, or RS232 as well as WIFI Direct. The peripheral device 20 controls the terminal equipment 40-46 respectively and switches among them via sending commands to the switching box 10.

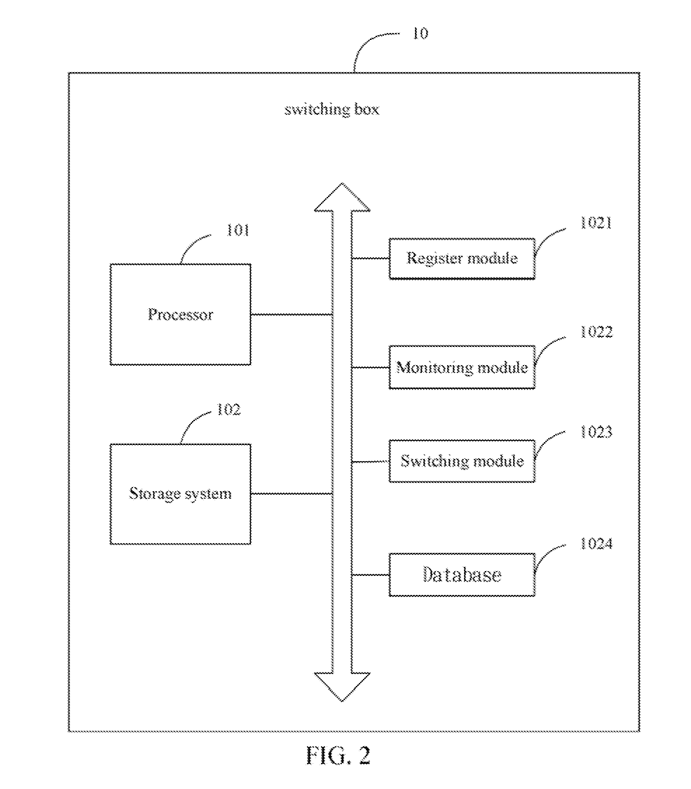

FIG. 2 is a block diagram of functional modules of the switching box 10 in FIG. 1. The switching box 10 includes a register module 1021, a monitoring module 1022 a switching module 1023, a database 1024, at least one processor 101, and a storage system 102. The modules 1021-1023 may include computerized code in the form of one or more programs that are stored in the storage system 102. The computerized code includes instructions that are executed by the at least one processor 101 to provide functions for the modules 1021-1023. In one example, the storage system 102 may include a hard disk drive, a flash memory, a cache, or another computerized memory device.

The register module 1021 regularly scans terminal equipment around the switching box 10 such as the terminal equipment 40-46. When new terminal equipment, for example, the terminal equipment 40, is detected, the register module 1021 assigns the terminal equipment 40 an SSID as a identifier, an exclusive frequency for connection, and an exclusive hot key to activate the switching process. All the information corresponding to the terminal equipment 40 is saved in a information table creating for the terminal equipment 40 in the database 1024. The switching box 10 and the terminal equipment 40 are then connected via WIFI Direct by the way of “persistent-connect,” at the exclusive frequency of the terminal equipment 40. The SSID of the terminal equipment 40 is also used as a name of the group formed by the switching box 10 and the terminal equipment 40, which takes the switching box 10 as group owner. Now, the terminal equipment 40 is successfully registered, instructed by the switching box 10.

In one embodiment, the exclusive hot key corresponds to operation of a user on the peripheral device 20 and is preset by the user, which can be a key operation or a combination of more than one key operation, a click operation or a touch operation, a combination of more than one click operation or a combination of more than one touch operation, or a button.

In one embodiment, the information table of the terminal equipment 40 further comprises connection information of the terminal equipment 40 such as the connecting times, for example, the information table is created while the terminal equipment 40 is registering, the connecting times are 0. The connecting times changes to 1 after the terminal equipment 40 register finishes registering. The SSID of the terminal equipment 40 is randomly assigned by the switching box, but can also be characteristics of the terminal equipment 40 such as MAC address or other characteristic identifiers.

The monitoring module 1022 persistently monitors for any exclusive hot key to be triggered on the peripheral device 20 by the user and searches the corresponding terminal equipment and the corresponding exclusive frequency once there is an exclusive hot key triggered. Information searched would be sent to the switching module 1023 and the monitoring module 1022 would inform the switching module 1023 to initiate the switching process among the terminal equipment.

The switching module 1023 initiates the switching process when there is an exclusive hot key triggered. Switching the terminal equipment 40 to the terminal equipment 42 is used as an example to describe the switching process in detail. Before switching, the peripheral device controls the terminal equipment 40, but the peripheral device 20 controls the terminal equipment 42 after the switching process ends. The switching module 1023 saves the information of the currently connected terminal equipment to the database 1024, maintaining all information in the database 104 that is updated. A connection between the switching box 10 and the terminal equipment 40 is then cut off and the switching box 10 returns to work at the exclusive frequency of the terminal equipment 42. The terminal equipment 42 is connected to the switching box 10 via WIFI Direct, and forms a group with the switching box 10 in the WIFI Direct network. Now, the peripheral device 20 can control the terminal equipment 42 instead of the terminal equipment 40.

In one embodiment, the group is named SSID, which is an identifier of the terminal equipment 42 assigned by the switching box 10 when registering, and the group owner is the switching box 10. In one embodiment, if the terminal equipment 42 is connected first, the connection would be “persistent-connect” and “re-association” would be adopted if not.

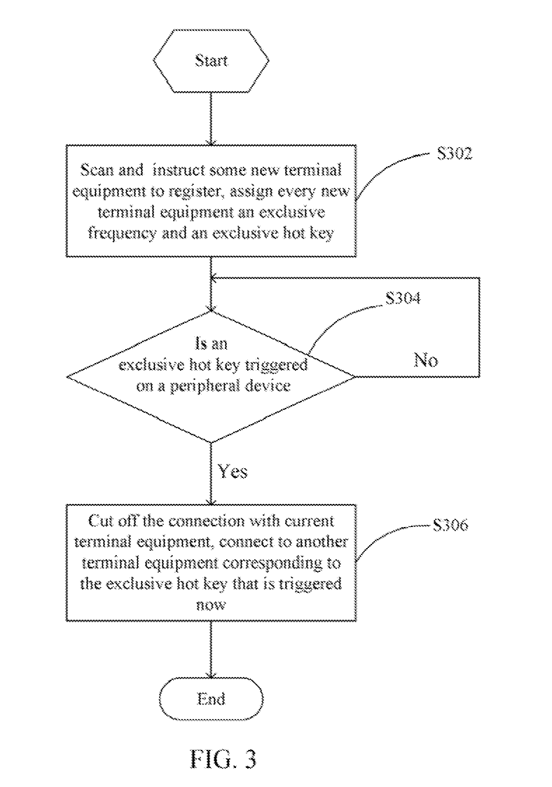

FIG. 3 shows a flowchart of one embodiment of a method of sharing peripheral devices. In the embodiment, the method is carried out in the application environment illustrated in FIG. 1, and is executed by (inter alia) the modules described in FIG. 2.

In block S302, The register module 1021 regularly scans to detect terminal equipment around the switching box 10 and inducts new terminal equipment for registration when new terminal equipment is detected. Using the terminal equipment 40 as an example, the module 1021 assigns the terminal equipment 40 an exclusive frequency for connection, and an exclusive hot key reminding when the switch is triggered.

In block S304, the monitoring module 1022 persistently listens if any command from the peripheral device 20 is input. Once there is an exclusive hot key triggered on the peripheral device 20, the monitoring module 1022 searches the corresponding terminal equipment and the corresponding exclusive frequency. For example, when the exclusive hot key of the terminal equipment 42 is triggered, the monitoring module is certain that the desired device is now the terminal equipment 42, and obtain the exclusive frequency of the terminal equipment 42 after searching. Information searched would be sent to the switching module 1023, and the monitoring module 1022 would inform the switching module 1023 to initiate the switching process.

In block S306, the switching module 1023 initiates the switching process when receiving a command from the monitored module 1022. Switching the terminal equipment 40 to the terminal equipment 42 is used as an example to describe the detail of the switching process. A connection between the switching box 10 and the terminal equipment 40 is cut off and the switching box 10 turns to work at the exclusive frequency of the terminal equipment 42. The terminal equipment 42 is then connected to the switching box 10 via WIFI Direct, and the peripheral device 20 can control the terminal equipment 42 instead of the terminal equipment 40. A method of sharing the peripheral device is executed via the switching box 10.

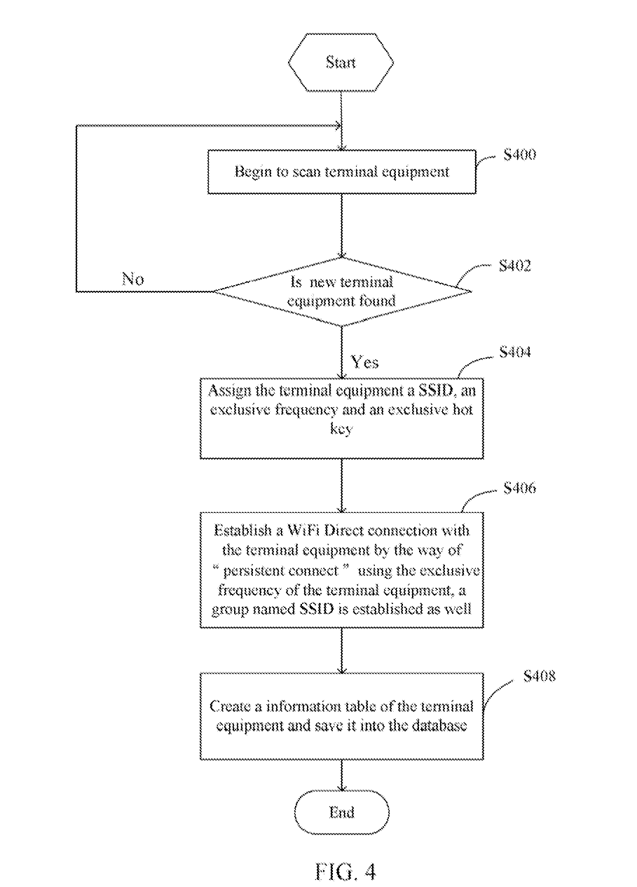

FIG. 4 is a flowchart of one embodiment of registering of one terminal equipment in FIG. 1. The process is lead by the switching box. In the described embodiment, the method is carried out in the application environment illustrated in FIG. 1, and is executed by the modules described in FIG. 2.

In block S400, the register module 1021 regularly scans terminal equipment around the switching box 10 such as the terminal equipment 40-46. Drivers are preinstalled in the terminal equipment in reflection to the scan and the scan interval is defined by the user, such as 5 minutes.

In block S402, when a new terminal equipment, for example, the terminal equipment 40 is detected, the terminal equipment 40 informs the register module 1021 that a new terminal equipment (the terminal equipment 40) is joining. The registration process is then initiated. Otherwise, the register module 1021 will continue scanning as described in block S400 until a new terminal equipment is detected.

In block S404, the register module 1021 assigns the terminal equipment 40 an SSID as a identifier, an exclusive frequency for connection, and an exclusive hot key for switching to the terminal equipment 40 when triggered. In one embodiment, the exclusive hot key corresponds to an operation of the user on the peripheral device 20 and is preset by the user, which can be a key operation or a combination of more than one key operation, a click operation or touch operation, a combination of more than one click operation, a combination of more than one touch operation, or a button.

In block S406, the switching box 10 forms a group with the terminal equipment 40 via WIFI Direct and acts as group owner. In the group whose name is the SSID of the terminal equipment 40, the connection frequency is the exclusive frequency of the terminal equipment 40. The switching box 10 communicates with the terminal equipment 40 at the exclusive frequency of the terminal equipment 40. “Persistent-connect” is adopted because the terminal equipment 40 is first connected when registering.

In block S408, the register module 1021 creates an information table in the database 1024 for the terminal equipment 40, where all the information of the terminal equipment 40 is saved, including the SSID, the exclusive frequency, the exclusive hot key and the connection information (such as connecting times), for example.

By the steps and method described above, any terminal equipment with preinstalled driver around the switching box 10 can register successfully and have the chance to share the peripheral device 20.

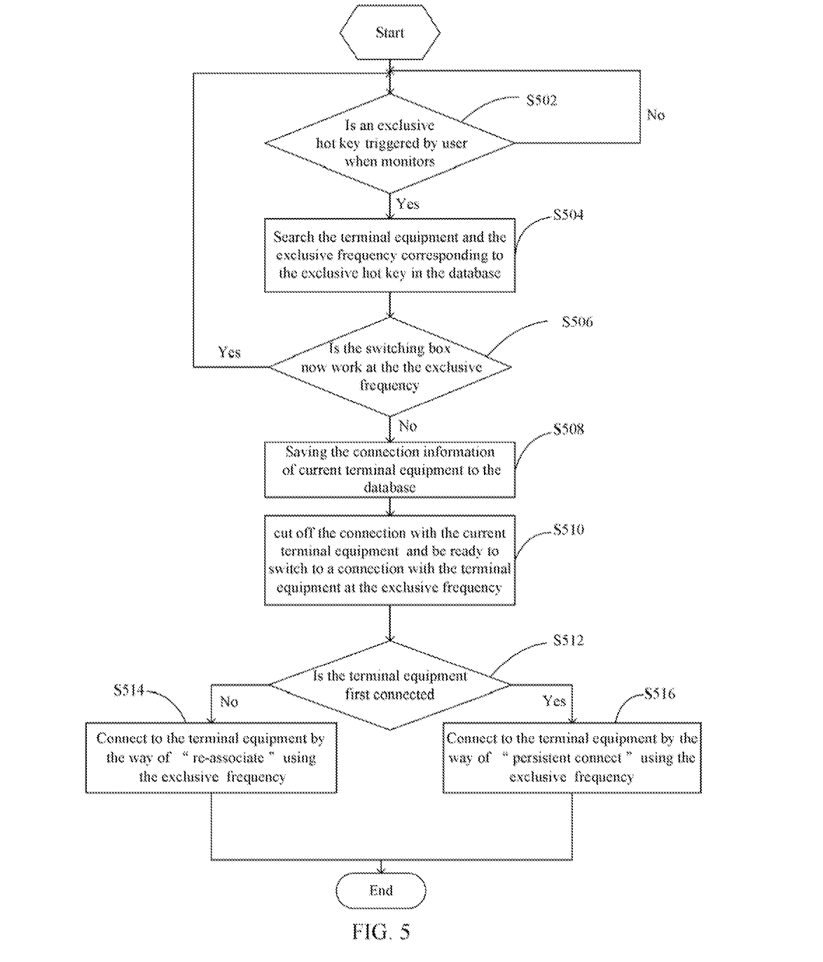

FIG. 5 is a flowchart of one embodiment of the switching box 10 to switch one terminal equipment. In the embodiment, the method is carried out in the application environment illustrated in FIG. 1, and is executed by the modules described in FIG. 2. In the embodiment, the switching box 10 switches the terminal equipment 40 to the terminal equipment 42.

In block S502, the monitoring module 1022 maintains monitoring if a hot key is triggered on the peripheral device 20. When an exclusive hot key is triggered, the process continues to block S604.

In block S504, the monitoring module 1022 searches the corresponding terminal equipment (the terminal equipment 42) and the corresponding exclusive frequency as well as other information of the terminal equipment 42, such as the SSID and the connecting times. All the information searched can be used when establishing a new connection between the switching box 10 and the terminal equipment 42.

In block S506, the switching module 1023 first determines whether a current connection is correct, and if the frequency of the current connection is matched with the exclusive frequency of the terminal equipment 42, there is no switch. Otherwise, the switching process continues to block S508.

In block S508, The switching module 1023 saves the information of the current connected terminal equipment (the terminal equipment 40) to the database 1024, and maintaining that all information in database 104 is updated.

In block S510, the switching module 1023 cuts off the connection between the switching box 10 and the terminal equipment 40, and ready to establish a new connection between the switching box 10 and the terminal equipment 42.

In block S512, the switching module 1023 first determines whether it is the first time for the terminal equipment 42 to be connected. If it is the first time, then the process goes to block S516, where the terminal equipment 42 is connected to the switching box 10 by the way of “persistent-connect” at the exclusive frequency of itself. Otherwise, the process goes to block S514, where the terminal equipment 42 is connected to the switching box 10 by the way of “re-association” at the exclusive frequency of itself.

In one embodiment, the process of establishing a connection between the switching box 10 and the terminal equipment 42 is as follows.

The switching box 10 and the terminal equipment 42 forms a group in the WIFI Direct network and the switching box 10 acts as group owner.

The group is named SSID, which is the SSID of the terminal equipment 42 and can be found when searching in block S504.

The communication frequency in the group, between the switching box 10 and the terminal equipment 42, is the exclusive frequency of the terminal equipment 42.

The connection way between the switching box 10 and the terminal equipment 42 is by “re-association,” or “persistent-connect,” depending on the determination made by the switching module 1023 in block S512.

In one embodiment, the quantity of the group in the WIFI Direct network depends on the quantity of the registered terminal equipment. The switching box 10 is the group owner of every group and distinguishes them by different SSID. The communication frequency in one group is the exclusive frequency of the terminal equipment in the group.

In summary, the switching box 10 method of sharing the peripheral device 20 can help a plurality of terminal equipment share the same peripheral device in a WIFI Direct network. The switching box and the terminal equipment communicate without transport line and traditional network, which makes the sharing of the peripheral much more convenient, environmental and economical as well as saving much more space.

While various embodiments and methods have been described above, it should be understood that they have been presented by way of example only and not by way of limitation. Thus the breadth and scope of the present disclosure should not be limited by the above-described embodiments, and should be at least commensurate with the following claims and their equivalents.

What is claimed is:

1. A switching box, connected to at least one peripheral device and a plurality of terminal equipment, for sharing the at least one peripheral device among the terminal equipment, the switching box comprising at least one processor, a storage system, and one or more programs stored in the storage system and executed by the at least one processor, the one or more programs comprising:
a register module that receives registration of the terminal equipment, and assigns each of the terminal equipment an exclusive frequency for connection and an exclusive hot key;
a monitoring module that monitors operations of a user on the at least one peripheral device to determine whether any of the exclusive hot keys is triggered; and
a switching module that cuts off a connection between the switching box and one of the terminal equipment that is currently connected to the switching box when one of the exclusive hot keys is triggered, and then connects to another one of the terminal equipment that corresponds to the triggered exclusive hot key at the exclusive frequency of the another one of the terminal equipment.

2. The switching box of claim 1, wherein the register module further creates an information table to store information of each of the terminal equipment.

3. The switching box of claim 2, wherein the information comprises the exclusive frequency and the exclusive hot key, and the monitoring module further searches the information of the another one terminal equipment corresponding to the triggered exclusive hot key in the information table.

4. The switching box of claim 2, wherein the switching module further communicates with the terminal equipment via WIFI Direct, and forms a wireless network with the terminal equipment.

5. The switching box of claim 4, wherein the information of the terminal equipment comprises an SSID of the terminal equipment.

6. The switching box of claim 5, wherein the switching module further establishes a group in the wireless network between the switching box and the another one of the terminal equipment, uses the SSID of the another one of the terminal equipment as a name of the group, and causes the switching box to function as a group owner of the group.

7. The switching box of claim 2, wherein the information of the terminal equipment comprises connecting times of each of the terminal equipment being connected to the switching box.

8. The switching box of the claim 7, wherein the switching module further connects to the another one of the terminal equipment by way of persistent-connect when the connection times of the another terminal equipment equals 0, and connects to the another one of the terminal equipment by way of re-association when the connecting times of the another terminal equipment is greater than 0.

9. A method applying in a switching box connected to at least one peripheral device and a plurality of terminal equipment for sharing the at least one peripheral device among the terminal equipment, the method comprising:
receiving registration of the terminal equipment, and assigning each of the terminal equipment an exclusive frequency for connection and an exclusive hot key;
monitoring operation of a user on the at least one peripheral device to determine whether any of the exclusive hot keys is triggered, and
cutting off a connection between the switching box and one of the terminal equipment that is currently connected to the switching box when one of the exclusive hot keys is triggered; and
connecting to another one of the terminal equipment corresponding to the triggered exclusive hot key at the exclusive frequency of the another one of the terminal equipment.

10. The method of claim 9, further comprising:
creating an information table to store information of each of the terminal equipment.

11. The method of claim 10, wherein the information comprises the exclusive frequency and the exclusive hot key, and the method further comprises searching the information of the another one of the terminal equipment corresponding to the triggered exclusive hot key in the information table.

12. The method as described in claim 10, further comprising:
communicating with the terminal equipment via WIFI Direct; and
forming a wireless network with the terminal equipment.

13. The method as described in claim 12, wherein the information of the terminal equipment comprises an SSID of the terminal equipment.

14. The method as described in claim 13, further comprising:
establishing a group in the wireless network between the switching box and the another one of the terminal equipment;
using the SSID of the another one of the terminal equipment as a name of the group; and
causing the switching box to function as a group owner of the group.

15. The method as described in claim 10, wherein the information of the terminal equipment comprises connecting times of each of the terminal equipment being connected to the switching box.

16. The method as described in claim 15, further comprising:
connecting to the another one of the terminal equipment by way of persistent-connect when the connecting times of the another one of the terminal equipment equals 0; and
connecting to the another one of the terminal equipment by way of re-association when the connection times of the another one of the terminal equipment is greater than 0.
